(19) United States
(12) Patent Application Publication
(10) Pub. No.: US 2026/0292384 A1
(43) Pub. Date: Sep. 24, 2026

(54) EAR DEVICE

(71) Applicant: CASIO COMPUTER CO., LTD., Tokyo (JP)

(72) Inventor: Reigo RYU, Tokyo (JP)

(73) Assignee: CASIO COMPUTER CO., LTD., Tokyo (JP)

(21) Appl. No.: 19/576,706

(22) Filed: Mar. 24, 2026

(30) Foreign Application Priority Data
Mar. 24, 2025 (JP) 2025-048612

(51) Int. Cl. H04R 1/10

(52) U.S. Cl. CPC H04R 1/1016; H04R 1/105

(57) ABSTRACT

An ear device includes, a main body that is placed on a back side of an auricle and that is provided with a battery; a sound emitter that is placed in a concha cavity and that includes a sound emitting hole which emits sound output from a speaker; and a coupler that couples the main body and the sound emitter. An ear tip including a sound conduit inside can be attached to and detached from the sound emitter. A sound emitting direction in which the sound conduit extends and a depth direction of the ear canal are different in a state that the ear tip is in use with the ear tip attached to the sound emitter.

### CROSS-REFERENCE TO RELATED APPLICATION(S)

The present application claims priority under Paris Convention to Japanese Patent Application No.2025-048612, filed on March 24, 2025, the disclosure of which, including description, claims, abstract and drawings, is incorporated herein by reference in its entirety for all purposes.

### BACKGROUND OF THE INVENTION

### FIELD

The present disclosure relates to an ear device.

### DESCRIPTION OF RELATED ART

Conventionally, various types of ear devices that are worn in an ear are known. For example, Japan Patent Application Publication No. 2013-115799 describes a bone-conduction type ear-mounted hearing aid as an ear device. FIG. 4 of this Patent Document illustrates how an ear-mounted hearing aid is worn like an ear cuff from a front side of the ear, which is an entrance side of an ear canal, around to a temporal side, which is a back side of the ear.

### SUMMARY

An ear device according to an aspect of the present disclosure includes,

a main body that is placed on a back side of an auricle and that is provided with a battery;

a sound emitter that is placed in a concha cavity and that includes a sound emitting hole which emits sound output from a speaker; and

a coupler that couples the main body and the sound emitter,

wherein,

an ear tip including a sound conduit inside can be attached to and detached from the sound emitter,

a sound emitting direction in which the sound conduit extends and a depth direction of the ear canal are different in a state that the ear tip is in use with the ear tip attached to the sound emitter.

### BRIEF DESCRIPTION OF DRAWINGS

FIG. 1 is a perspective view of a main part showing a state in which an ear tip with a long sound conduit is attached to an ear device according to the present embodiment.

FIG. 2 is a perspective view of a main part showing the state in which the ear tip with the long sound conduit is attached to the ear device according to the present embodiment.

FIG. 3 is a schematic view of the main part showing the state of the ear device illustrated in FIG. 1 and FIG. 2 attached to an ear.

FIG. 4 is a schematic cross-sectional view of the main part showing a sound emitting section with the ear tip attached.

FIG. 5 is a perspective view of the main part showing an example of a plurality of ear tips that are prepared in a state attachable to the sound emitting section according to the present embodiment.

FIG. 6 is a perspective view of the main part showing the state in which the ear tip with a short sound conduit is attached to the ear device according to the present embodiment.

FIG. 7 is a descriptive diagram illustrating a portion of the ear device according to the present embodiment, specifically, the portion that comes into contact with the ear.

FIG. 8 is a descriptive diagram illustrating an example of an amount of tilt of the ear device shown in FIG. 7 when the ear device is worn in the ear.

FIG. 9 is a schematic perspective view of the main part showing the state in which the ear device according to the present embodiment is worn in the ear, and a descriptive diagram showing how a sound emitting side end of the ear tip is positioned on an inner side of a tragus.

FIG. 10 is a schematic perspective view of the main part showing a state of the ear tilted to a position where an ear canal entrance is visible from the state shown in FIG. 9, and a descriptive diagram showing how the sound emitting side end of the ear tip is positioned on the outer side of the ear canal entrance.

FIG. 11 is a descriptive diagram showing that a sound emitting direction of the ear tip and a depth direction of an ear canal are different.

FIG. 12 is a schematic descriptive diagram of the state of the ear device according to the present embodiment worn in the ear viewed from overhead.

FIG. 13 is a schematic cross-sectional view along line XIII-XIII shown in FIG. 12.

### DETAILED DESCRIPTION

A shape of an ear varies depending on a user, and there are individual differences in a distance between a position of a sound emitting hole that emits sound and a position to an ear hole (ear canal entrance) of the user.

With a type of ear device that outputs vibrations from a bone-conduction driver, such as those disclosed in Japan Patent Application Publication No. 2013-115799, there is no need to worry about variations in the distance from the sound emitting hole to the ear hole.

However, when the sound is output from a speaker, acoustic characteristics of the output sound vary depending on the distance from the sound emitting hole to the ear hole, making it difficult to achieve optimal hearing for the user.

The present disclosure has an advantage of accommodating individual user differences in the distance from the sound emitting hole to the ear canal entrance.

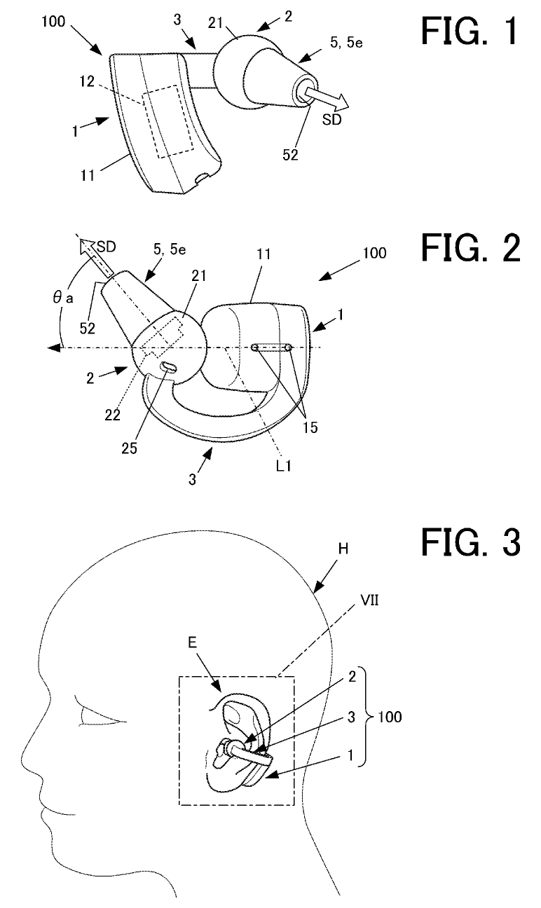

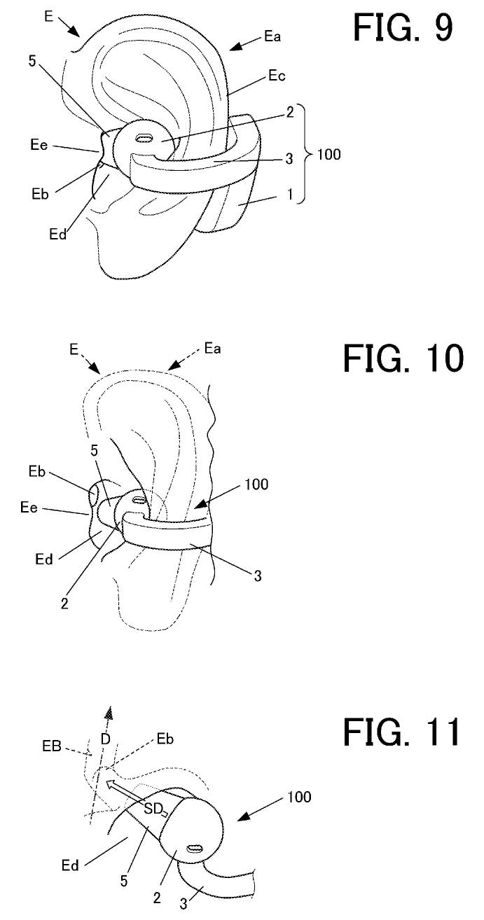

With reference to FIG. 1 to FIG. 13, one embodiment of the ear device 100 according to the present disclosure will be described. As shown in FIG. 3, an ear device 100 according to the present embodiment is used by wearing the ear device 100 on an ear E. As shown in FIG. 1 and FIG. 2, etc., the ear device 100 includes a main body section 1 (main body), a sound emitting section 2 (sound emitter), and a coupling section 3 (coupler) coupling the main body section 1 and the sound emitting section 2. In FIG. 1, FIG. 2, etc., a sound emitting direction (output direction) SD is indicated by a white arrow. The sound emitting section 2, which is placed on a front side of the ear E (concha cavity Ed shown in FIG. 9 and FIG. 10) and the main body section 1, which is placed on a back side of the ear E are coupled with the coupling section 3. With this, the main body section 1 and the sound emitting section 2 sandwich the auricle Ea from the front and back, and the ear device 100 is latched to the ear E (see FIG. 3, etc.). As shown in FIG. 3, etc., the coupling section 3 is placed on the front and back of the ear E across a helix Ec (outer edge of the ear E), giving an appearance as if an ear cuff is being worn. The embodiment described below is provided with various limitations technically preferable for implementing the present disclosure. However, the scope of the present disclosure is not limited to the embodiment below or illustrated examples.

The main body section 1 includes a housing 11 formed with various resins, for example, and includes at least a battery 12 (see FIG. 1), which is a power supply unit, in the housing 11. The main body section 1 also contains a communication module for wireless communication by Bluetooth (registered trademark), for example, and various boards (none of which are shown). The main body section 1 is positioned on the back side of the ear E, between the ear E and the head H. A positional relationship between the main body section 1 and the sound emitting section 2 is set so as to be positioned approximately on the front and back side of the ear E with the concha cavity Ed in between toward the ear canal entrance Eb side than the helix Ec (see FIG. 9). The main body section 1 is heavier than the sound emitting section 2 due to the weight of the battery 12, etc. contained inside. Therefore, in a worn state, the main body section 1 located on the back side of the ear E is slightly lower in a direction of gravity than the sound emitting section 2 on the front side of the ear E. As shown in FIG. 3, etc., the entire ear device 100 tilts slightly toward the back.

When the ear device 100 is a sound collector or hearing aid, a microphone 15 is provided in the main body section 1, as shown in FIG. 2, etc. In the illustrated example, two microphones 15 are positioned in a portion which is to be the upper side of the main body section 1 in a worn state. The position and number of microphones 15 are not limited to the illustrated example. The microphone 15 is a sound wave input section (sound collecting section) that collects sound waves (sound data) from the outside. The sound waves (sound data) collected by the microphone 15 are input to an amplifier (not shown), converted into electrical signals, and amplified as appropriate. Furthermore, the amplified electrical signals are supplied to a speaker unit 22 (see FIG. 4) of the sound emitting section 2, which is described below, and converted into the sound.

The sound emitting section 2 includes a housing 21 formed with various resins, for example. In the example shown in FIG. 2, etc., an outer shape of the housing 21 is formed in a substantial spherical shape. The shape of the housing 21 is not limited to the illustrated example. The inside of the housing 21 houses a speaker (hereinafter referred to as speaker unit 22), etc. The speaker unit 22 converts the electrical signals into the sound and is equipped with, for example, a diaphragm, coil, magnet, etc. (all not shown). When the ear device 100 is an earphone, the electrical signals (audio signals) supplied from an external device are converted into the sound (vibration) by the speaker unit 22. When the ear device 100 is a sound collector or a hearing aid, the electrical signals (voice signals) based on the sound collected by the microphone 15 provided in the main body section 1 and amplified by the amplifier are converted into the sound (vibration) in the speaker unit 22.

The housing 21 includes a sound outlet section 23 protruding from one end side of a spherical outer circumference section. A free end side of the sound outlet section 23 is provided with a sound emitting hole 23a, which outputs (emits) the sound (vibration) converted from electrical signals (audio signals) in the speaker unit 22 to the outside. In the worn state of the ear device 100, the sound emitting section 2 is positioned in the concha cavity Ed, at which time the sound emitting hole 23a provided on the free end side of the sound outlet section 23 opens toward the ear canal entrance Eb side in the concha cavity Ed. A latching recess section 24 is formed in substantially the entire circumferential direction in the outer circumference section of a base side of the sound outlet section 23. The latching recess section 24 is a substantial U-shaped groove in the cross-sectional view, as shown in FIG. 4. In addition, a sound emitting port 25 for sound emission is formed in the upper side portion of the sound emitting section 2 in the worn state. The sound emitting port 25 is an aperture that emits the sound (vibration) in a phase opposite to the sound (vibration) output from the sound emitting hole 23a.

In the ear device 100 according to the present embodiment, an ear tip 5 can be attached to and detached from the sound emitting section 2. The ear tip 5 is preferably made of silicone or urethane resin, for example, and is elastically deformable. A connection section 51 is formed on one end side of the ear tip 5. The connection section 51 is an inward-facing flange section formed on one end side of the ear tip 5, which is latched to the latching recess section 24 of the sound emitting section 2 when attached to the sound emitting section 2. In other words, as shown in FIG. 4, the connection section 51 of the present embodiment is shaped to fit into the latching recess section 24. When the ear tip 5 is attached to the sound emitting section 2, the connection section 51 is fitted into the latching recess section 24 to be latched, and the connection section 51 is latched into the latching recess section 24 like a hook to maintain a latched state. The specific shape of the latching recess section 24 and the connection section 51 of the ear tip 5 that is latched with the latching recess section 24 is not limited to the illustrated example, as long as they fit together and may be shaped in any shape that it is difficult to pull out once the connection section 51 is latched.

The ear tip 5 includes a sound conduit 55 that penetrates internally in a sound emitting direction SD. The sound conduit 55 leads the sound output from the speaker unit 22 of the sound emitting section 2 to the sound emitting hole 52 provided on the tip side of the ear tip 5. In the ear device 100 according to the present embodiment, the length of the sound conduit 55 can be adjusted in the sound emitting direction SD by attaching the ear tip 5 to the sound emitting section 2. In other words, in a state without the ear tip 5, the sound output from the speaker unit 22 is emitted from the sound emitting hole 23a, and the sound output from the speaker unit 22 is guided in the sound emitting direction SD only for the length of the sound outlet section 23. In contrast, in a case in which the ear tip 5 is attached to the sound emitting section 2, the sound is guided by the sound conduit 55 to a position farther from the speaker unit 22 in the sound emitting direction SD than in a case in which the sound is emitted from the sound emitting hole 23a of the sound emitting section 2, and the sound can be emitted from the sound emitting hole 52 on the tip side of the ear tip 5.

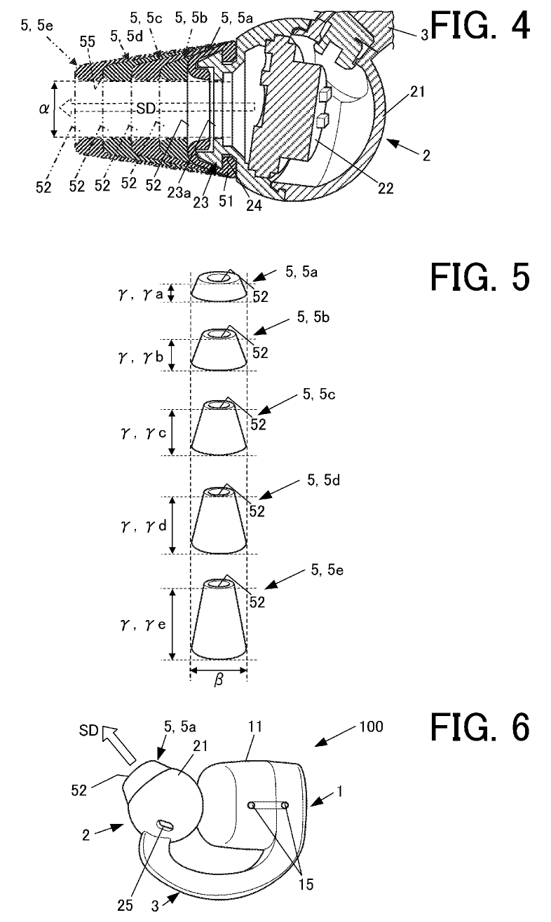

According to the present embodiment, as shown in FIG. 4 and FIG. 5, multiple types (five types in the illustrated example) of ear tips 5, each with a different length of the sound conduit 55, are available for replacement, and one ear tip 5 selected from the multiple ear tips 5 (ear tips 5a to 5e) is attached to the sound emitting section 2. The ear tip 5 that can be attached to the sound emitting section 2 is not limited to the case where five types of ear tips are available. For example, the ear tip 5 may be available in three types (S, M, L) or two types (S, L), or six or more types of ear tips 5 may be available. The ear tip 5 may be one type, and may be used in two ways such as the use without attaching the ear tip 5, or the use attaching the ear tip 5 with the length of the ear tip 5 (the length of the sound conduit 55) increased in the amount of the length of the ear tip 5 so that the length by which the sound is guided in the sound emitting direction SD is increased.

In FIG. 4, the five types of ear tips 5 are shown virtually stacked on top of each other for illustration purposes. That is, in FIG. 4, an ear tip 5a, which has the sound conduit 55 with the shortest length, is shown with a solid line, and ear tips 5bto 5e, which have the sound conduit 55 with a length longer than that of the ear tip 5a, are shown as double-dotted dash lines. Each of the ear tips 5 has almost the same structure, except that the length of the sound conduit 55 is different. In other words, the sound conduits 55 of the ear tips 5a to 5e are all formed in a substantial cylindrical shape, and an inner diameter α of the sound conduit 55 (see FIG. 4) is also substantially equal. The shape of the connection section 51, which is latched in the latching recess section 24 of the sound emitting section 2, is common. Therefore, as shown in FIG. 5, a length (width) β of one end of the ear tip 5, where the connection section 51 is formed (the end of the connection side with the sound emitting section 2), is common to all ear tips 5a to 5e.

As shown in FIG. 4 and FIG. 5, the outer shape of the ear tip 5 is in a substantial conical shape with a smaller cross-sectional area toward the sound emitting direction SD. In other words, the other end (sound emitting side) of the ear tip 5, where the sound emitting hole 52 is provided, has a smaller diameter and a more tapered shape than the one end (the end on the connecting side with the sound emitting section 2) where the connection section 51 is formed. In FIG. 1 and FIG. 2, the ear tip 5e in which the length of the sound conduit 55 is the longest is shown in the state attached to the sound emitting section 2. In FIG. 6, the ear tip 5a in which the length of the sound conduit 55 is the shortest is shown in the state attached to the sound emitting section 2. In FIG. 5, the length of the ear tip 5a in the height direction (substantially corresponding to the length of the sound conduit 55 in the ear tip 5a) is "γa", and similarly, the length of the ear tip 5b in the height direction is "γb", the length of the ear tip 5c in the height direction is "γc", the length of the ear tip 5d in the height direction is "γd", the length of the ear tip 5e in the height direction is "γe". As shown in FIG. 5, the length γa of the ear tip 5a has the shortest length and the length γe of the ear tip 5e has the longest length. In both cases, the shape of the ear tip 5 is such that the ear tip 5 has the largest length (width) β at the end of the connection side with the sound emitting section 2 in the sound emitting direction SD, and the length (width) becomes smaller towards the end of the sound emitting side in the sound emitting direction SD.

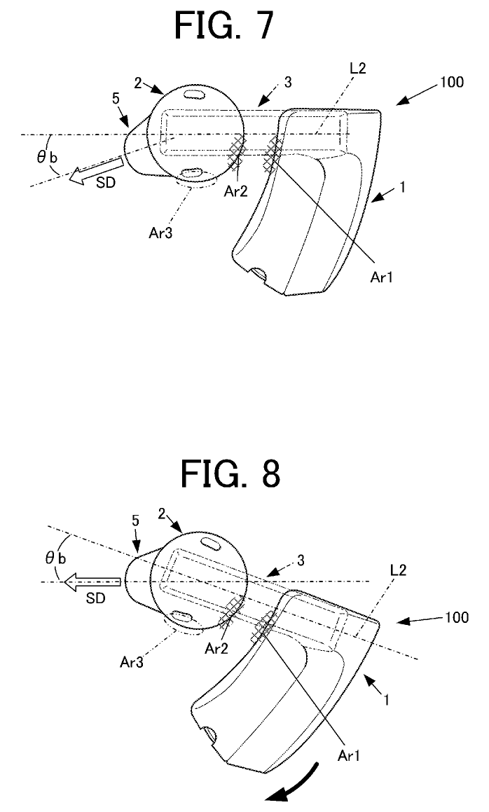

According to the present embodiment, the latching recess section 24 is configured so that the tip side of the ear tip 5 faces diagonally down (diagonally down to the left in the example shown in FIG. 7) when the coupling section 3 is in a substantial horizontal position, as shown in FIG. 1 and FIG. 7, for example. As mentioned above, in the worn state of the ear device 100 according to the present embodiment, the main body section 1 side, which carries the relatively heavy battery 12, is lowered in the direction of gravity, causing the coupling section 3 to also tilt backward diagonally as shown in FIG. 3 and FIG. 8 (see bold arrow in FIG. 8). When in this state, the tip side of the ear tip 5 attached to the sound emitting section 2 faces in a substantial horizontal direction, and the sound emitting direction SD is also in the substantial horizontal direction (see FIG. 8).

As shown in FIG. 9 and FIG. 10, when the ear tip 5 is used by being attached to the sound emitting section 2, preferably, the sound emitting side end of the ear tip 5 (the portion where the sound emitting hole 52 is formed) is located on an inner side of the tragus Ee (or, even if it does not go all the way to the inner side of the tragus Ee, about plus or minus a few mm from the position of the edge (outline) of the tragus Ee) and outside the ear canal EB (that is, outside than the ear canal entrance Eb). The sound emitting side end of the ear tip 5 is placed on the inner side (or near) of the tragus Ee, and with this, it is expected to prevent sound leakage. Preferably, the sound emitting side end of the ear tip 5 is placed on the inner side (or near) of the tragus Ee and near the ear canal entrance Eb, but is not in contact with the ear E itself, including the tragus Ee and the ear canal entrance Eb. The space in the concha cavity Ed, especially on the back side of the tragus Ee where the tip side of the ear tip 5 is located, is relatively narrow, but as mentioned above, the tip side of the ear tip 5 is shaped to gradually become thinner. This makes it easy to be placed in a tight space without difficulty. The shape, configuration, and materials used to form the ear tip 5 are not particularly limited. For example, the portion of the ear tip 5 other than the sound conduit 55 may be solid or hollow.

In a case in which the ear device 100 is used without inserting the sound emitting section 2 or the ear tip 5 into the ear canal entrance Eb, the distance from the portion where the sound is emitted (output) (sound emitting holes 23a and 52) to the ear canal entrance Eb is preferably about 5 mm in order to hear clear sound with good acoustic characteristics. However, the size and the shape of the ear E varies from person to person. For example, in the case of the user with the large ear E and the wide concha cavity Ed, if the sound emitting section 2 is placed in the concha cavity Ed, the sound emitting hole 23a of the sound emitting section 2 and the sound emitting hole 52 of the ear tip 5 may be too far from the ear canal entrance Eb, and the functions sought by the user such as good sound quality and hearing supplement effect may not be obtained sufficiently. There is an individual difference (variation) of about 10 mm in the distance from the portion where the sound is emitted (output) (sound emitting holes 23a and 52) to the ear canal entrance Eb. In this respect, the ear device 100 according to the present embodiment can overcome this individual difference by replacing the plurality of ear tips 5 (ear tips 5a to 5e). The user can choose whether or not to attach the ear tip 5, and if attached, which ear tip 5 (ear tips 5a to 5e) is attached. For example, in the case of the user whose size of the ear E is small and the sound emitting hole 23a with nothing attached is placed just behind the tragus Ee, the ear device 100 may be used without attaching the ear tip 5.

As shown in FIG. 11, according to the present embodiment, the sound emitting direction SD of the ear tip 5 (the sound emitting direction SD in which the sound conduit 55 extends) and the depth direction D of the ear canal EB are different when the ear tip 5 is in use with the ear tip 5 attached. In other words, according to the present embodiment, in the state that the ear device 100 is worn on the ear E, the sound emitting side end of the ear tip 5 is placed on the inner side (or near) of the tragus Ee and near the ear canal entrance Eb, but the direction in which the ear canal EB extends is the depth direction D (the direction toward the inside of the head) shown in FIG. 11. This direction is different from the sound emitting direction SD of the ear tip 5.

The coupling section 3 is an arm-like portion that couples the main body section 1 and the sound emitting section 2. The sound emitting section 2 can receive electrical signals and power supply from the main body section 1 via the coupling section 3. The coupling section 3 is formed of, for example, elastically deformable resin, etc., and has a post inside, which is not shown in the figure. The post is made of metal, such as titanium, for example. The coupling section 3 that elastically deforms is supported by the metal post, which enables the coupling section 3 to maintain a stable state along the helix Ec. The sound emitting section 2 and the main body section 1 coupled by the coupling section 3 can pinch the helix Ec with moderate pressing force so that the ear device 100 can be held on the ear E. The coupling section 3 may wrap around the outer side of at least one of an antihelix of an outer ear, the helix Ec, or an earlobe.

As mentioned above, the coupling section 3 connects the main body section 1 and the sound emitting section 2 in a substantial horizontal direction (see FIG. 1 and FIG. 7), and when this state is viewed from above, as shown in FIG. 2, in plan view, from the center line L1 of the ear device 100 (the line connecting the center of the sound emitting section 2 and the center of the main body section 1) to the side where the coupling section 3 is not located, the angle θa inclined. According to the above embodiment, the angle θa is, for example, substantially 50 degrees. The angle θa is decided so that the sound emitting direction SD is favorably directed toward an ear canal direction. Here, the angle θa being set in the range of 40 to 60 degrees is acceptable because the sound emitting direction SD is oriented toward the ear canal direction. In the front view of the ear device 100, as shown in FIG. 7 and FIG. 8, the sound emitting direction SD is inclined at an angle θb in a diagonally downward (diagonally lower left in FIG. 7) direction relative to an extending direction (longitudinal direction) of the center of the coupling section 3 (center line L2 in FIG. 7 and FIG. 8). The angle θb is, for example, substantially about 20 degrees. In a state in which the ear device 100 is worn on the ear E, as shown in FIG. 8, the main body section 1 side is tilted downward in the direction of gravity and the sound emitting section 2 side is tilted in the upward direction (the thick arrow in FIG. 8 indicates that the main body section 1 is tilted downward to the right from the sound emitting section 2 and the sound emitting section 2 is tilted upward to the left from the main body section 1). By tilting the entire ear device 100 up to the left by the angle θb, the sound emitting direction SD becomes the substantially horizontal direction.

Next, the operation of the ear device 100 according to the present embodiment will be described. First, the user wears the ear device 100, selects the ear tip 5 appropriate for the size of his/her ear E, etc., and latches the connection section 51 of the ear tip 5 to the latching recess section 24 of the sound emitting section 2. This allows the length of the sound conduit 55 that leads the sound output from the speaker unit 22 of the ear device 100 to be adjusted. Here, how to select the ear tip 5 according to the size, etc. of the ear E is described. In the ear device 100 according to the present embodiment, as shown in FIG. 9 and FIG. 10, the sound emitting hole 52 of the ear tip 5, which is the end of the sound emitting direction SD of the emission (output) of the sound from the sound emitting section 2, is preferably located on the inner side (or near) of the tragus Ee and outside the ear canal EB. Therefore, the user tries one of the ear tips 5 (e.g., ear tip 5c) attached to the sound emitting section 2 and checks whether the sound emitting hole 52 of the ear tip 5 is positioned on the inner side (or near) of the tragus Ee and outside the ear canal EB when the ear device 100 is worn.

For example, in the case in which the sound emitting hole 52 of the ear tip 5 does not reach the inner side (or near) of the tragus Ee, the user judges that the length of the sound conduit 55 is insufficient for the size and shape of his/her ear E, and the ear tip 5 is replaced with the ear tip 5 with the longer sound conduit 55 (ear tip 5d, for example). Conversely, in the case in which the sound emitting hole 52 of the ear tip 5 enters into the ear canal entrance Eb, the user judges that the length of the sound conduit 55 is too long for the size and shape of his/her ear E, and the ear tip 5 is replaced with the ear tip 5 with the shorter sound conduit 55 (ear tip 5b, for example). In this way, the user can select the ear tip 5 that matches the size of his/her ear E and attach such ear tip 5 to the sound emitting section 2 by wearing the ear device 100 while trying the various types of ear tips 5. With this, the user can adjust the ear device 100 so that the sound emitting hole 52 is positioned on the inner side (or near) of the tragus Ee and outside the ear canal EB. Therefore, according to the present embodiment, the distance between the sound emitting hole 52 and the ear canal EB (ear canal entrance Eb) can be made constant, regardless of the size, etc. of the user's ear E.

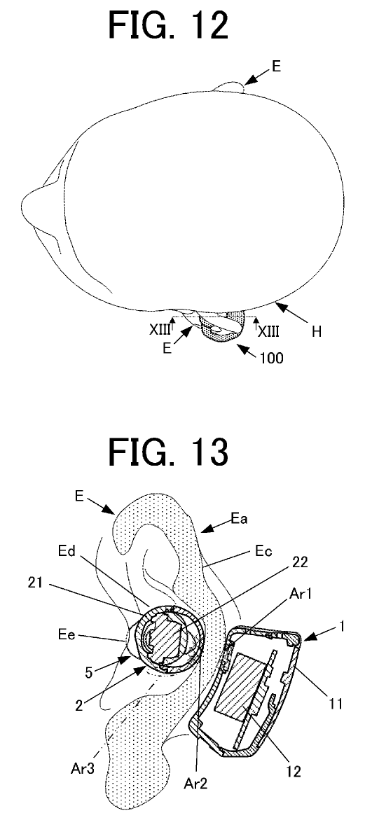

In the state in which the ear device 100 according to the present embodiment is worn on the ear E, the sound emitting section 2 is placed in the concha cavity Ed and the main body section 1 is placed behind the ear E (auricle Ea). With this, the ear device 100 is secured to the ear E by a first region Ar1 on the main body section 1 side and a second region Ar2 on the sound emitting section 2 side, as shown by hatching in FIG. 7 and FIG. 8, so that the ear E (auricle Ea) is pinched from the front and back (see FIG. 12). If this state is shown using the cross-section of the ear E, as shown in FIG. 13, the first region Ar1 on the main body section 1 side contacts the back side of the ear E, and the second region Ar2 on the sound emitting section 2 side contacts the front side of the ear E. Then, as mentioned above, the coupling section 3 is pulled by the main body section 1 which is heavier than the sound emitting section 2, and tilted toward the main body section 1 (angle θb in the embodiment), and the sound emitting section 2 side is lifted as the main body section 1 side is lowered in the direction of gravity (see FIG. 8 and FIG. 13). In this state, the sound emitting direction SD of the sound emitted from the sound emitting hole 52 is in the substantial horizontal direction as shown in FIG. 8. When the ear device 100 is worn, the lowest point of the sound emitting section 2 in the direction of gravity (third region Ar3 of the sound emitting section 2, indicated by the double-dotted dash line in FIG. 7, FIG. 8 and FIG. 13) is positioned not in contact with the concha cavity Ed, as shown in FIG. 13. In other words, the third region Ar3 which is the lowest point of the sound emitting section 2, is positioned floating in the air, so the sound emitting section 2 does not sit in the concha cavity Ed.

As described above, according to the present embodiment, the length of the sound conduit 55 is adjusted by the ear tip 5 to absorb variations in the size and shape of the ear E from user to user (individual differences). This makes it possible for anyone to listen to the sound with good acoustic properties without putting strain on the ear E using the ear device 100 according to the present embodiment.

As described above, the ear device 100 according to the present embodiment includes the following, the main body section 1, which is placed behind the auricle Ea and which is equipped with the battery 12; the sound emitting section 2, which is placed in the concha cavity Ed and which has the sound emitting hole 23a for emitting the sound output from the speaker unit 22; and the coupling section 3 that couples the main body section 1 to the sound emitting section 2. The ear tip 5 having the sound conduit 55 inside can be attached to and detached from the sound emitting section 2, and when the ear tip 5 is attached to the sound emitting section 2 and is in use, the sound emitting direction SD in which the sound conduit 55 extends and the depth direction D of the ear canal EB are different.

According to the ear device 100 of the present embodiment, it is possible to easily accommodate the size and shape of the user's ear E, etc. In other words, the length of the sound conduit 55 can be adjusted to fit the user's ear E. This allows the ear device 100 to be worn without any burden on the ear E by opening the ear canal (ear canal entrance Eb) in the present embodiment, and the length of the sound conduit 55 can be adjusted so that the distance is the distance with which the sound is the most easy to hear. With this, it is possible to set the acoustic characteristics so as to be able to listen to the good sound. This makes it possible to demonstrate functions such as sound quality and supplementary hearing effects set in the main body section 1, etc., without being affected by individual differences such as the size of the ear E. The design of the center of gravity of the main body section, which is the angle θb, and the design of the range of the distance between the Ar2 and Ar1 allow the ear device 100 to be worn without any burden on the ear E. Therefore, even when the ear device 100 is a sound collector, hearing aid, or the like that is often continuously worn on a daily basis, excellent wearing comfort and less burden on the user can be achieved.

According to the present embodiment, the sound emitting side end of the ear tip 5 is placed on the inner side of the tragus Ee and outside the ear canal EB. This allows the sound emitting hole 52, through which the sound is output (emitted), to be positioned on the inner side of the tragus Ee. The inner side of the tragus Ee is close to the ear canal entrance Eb and is a position suitable for listening to the output (emitted) sound. Thus, according to the present embodiment, the ear canal (ear canal entrance Eb) can be opened and the ear device 100 can be worn without any burden on the ear E. Moreover, the length of the sound conduit 55 can be adjusted to provide the most optimal distance for listening to the sound and it is possible to provide a state in which the good sound can be heard as the acoustic characteristic. In addition, by keeping the sound emitting hole on the inner side of the tragus Ee, it is difficult for the sound emitted from the sound emitting hole 52 to leak out into the surrounding environment. Especially when the ear device 100 is a sound collector or a hearing aid, the microphone 15 picks up the voices of the surrounding people and other nearby sounds, amplifies the sound with an amplifier, etc., and outputs the sound from the sound emitting section 2, but if the microphone 15 picks up the sound from the sound emitting hole, this causes acoustic feedback and other problems that can be disturbing to the ear. In this regard, the placement of the sound emitting hole on the inner side of the tragus prevents the microphone 15 from picking up the excessive sound from the sound emitting hole, improving the usability of the ear device 100.

The sound emitting side end of the ear tip may be positioned near the tragus Ee and outside the ear canal EB. In other words, even if the tip of the ear tip 5 is not necessarily located on the inner side of the tragus Ee but the position of the tip of the ear tip 5 is close to the tragus Ee (e.g., plus or minus 2 mm from the tragus Ee), the output (emitted) sound can be heard with good acoustic characteristics.

According to the present embodiment, preferably, the sound emitting side end of the ear tip 5 is positioned so that it does not contact the ear E. This reduces the sensation of wearing a foreign object on the ear E when the ear device 100 is worn, and reduces the burden on the user.

According to the present embodiment, the sound emitting direction SD is the direction opposite to the position of the coupling section 3 from the sound emitting section 2 (the direction above the center line L1 in FIG. 2) in the arrangement direction (the arrow direction of the center line L1 of the ear device 100 shown in FIG. 2) in which the sound emitting section 2 is arranged from the main body section 1 when in use. The coupling section 3 according to the present embodiment is positioned across the helix (outer edge of the ear E) Ec and connects the sound emitting section 2, which is positioned on the front side of the ear E, and the main body section 1, which is positioned on the back side. The sound emitting direction SD is the direction opposite to the position of this coupling section 3, so that the sound is emitted toward the inner side of the ear E. This makes it easy to hear the emitted sound.

According to the present embodiment, the sound emitting direction SD is an intermediate direction which is substantially the middle between the depth direction D of the ear canal EB and the direction of the array (i.e., the arrow direction of the center line L1 of the ear device 100 shown in FIG. 2). Thus, the sound from the sound emitting hole 52 is not output (emitted) directly into the ear canal EB, making it audible but not grating.

The ear device 100 according to the present embodiment is latched to the ear E by clamping the auricle Ea from the front and back by the main body section 1 and the sound emitting section 2. This allows the ear device 100 to be worn with the appearance as if the ear cuff were being worn.

The sound conduit 55 according to the present embodiment is a substantial cylinder. This allows the sound to be output without attenuation to the sound emitting hole 52 on the tip side of the ear tip 5, regardless of which size ear tip 5 is worn, so that the user can enjoy the clear sound with good acoustic characteristics.

The outer shape of the ear tip 5 according to the present embodiment is formed as a substantial cone whose cross-sectional area decreases toward the sound emitting direction SD. Although the space on the inner side of the concha cavity Ed, especially the inner side of the tragus Ee, is narrow, the tapered external shape of the ear tip 5 allows it to be placed in such a narrow space while avoiding interference with the surroundings.

The lowest point (third region Ar3 in FIG. 13, etc.) in the direction of gravity of the sound emitting section 2 when the ear device 100 according to the present embodiment is worn is positioned so that there is no contact with the concha cavity Ed. Thus, when the sound emitting section 2 is latched to the ear E in a state where there is space from the concha cavity Ed, the user is less likely to feel discomfort even after wearing the ear device 100 for a long time, making the ear device 100 with excellent wearing comfort.

In particular, according to the present embodiment, multiple types of ear tips 5 with different lengths of the sound conduit 55 are provided as ear tips 5 that can be replaced, and one ear tip 5 selected from the plurality of ear tips 5 is attached to the sound emitting section 2. Therefore, the user can easily adjust the length of the sound conduit 55 by selecting the ear tip 5 according to the size of his/her ear E, etc., and can listen to the sound with good acoustic characteristics.

Although an embodiment of the present invention is described above, needless to say the present invention is not limited to the embodiment and can be appropriately modified in a variety of aspects without departing from the scope of the present invention. For example, in the above embodiment, the sound conduit 55 of the ear tip 5 attached to the sound emitting section 2 of the ear device 100 is a substantial cylinder, but the shape of the sound conduit 55 is not limited to the substantial cylinder. For example, the sound conduit 55 may have a substantial conical shape with a larger cross-sectional area toward the sound emitting direction SD. In other words, a tapered shape is preferred as the external shape of the ear tip 5, but for the internal sound conduit 55, it is preferable from an acoustic point of view to be at least constant (not tapered) or widened toward the sound emitting direction SD. In this case, the tip side of the ear tip 5 becomes thin, but as long as it is possible to mold, the external shape may be tapered while the internal sound conduit 55 may be shaped to expand toward the sound emitting direction SD.

In the above, one or more embodiments of the present invention are described. However, the scope of the present invention is not limited thereto, and includes the scope of claims below and the scope of their equivalents.

1. An ear device comprising:
a main body that is placed on a back side of an auricle and that is provided with a battery;
a sound emitter that is placed in a concha cavity and that includes a sound emitting hole which emits sound output from a speaker; and
a coupler that couples the main body and the sound emitter,
wherein,
an ear tip including a sound conduit inside can be attached to and detached from the sound emitter,
a sound emitting direction in which the sound conduit extends and a depth direction of the ear canal are different in a state that the ear tip is in use with the ear tip attached to the sound emitter.

2. The ear device according to claim 1, wherein the ear device is latched to an ear by clamping the auricle from front and back of the auricle by the main body and the sound emitter.

3. The ear device according to claim 1, wherein a lowest point of the sound emitter in a direction of gravity when worn is positioned in a state in which there is no contact with the concha cavity, and in a state in which the sound emitter does not sit in the concha cavity.

4. The ear device according to claim 1, wherein a sound emitting side end of the ear tip is positioned on an inner side of a tragus and outside an ear canal.

5. The ear device according to claim 1, wherein a sound emitting side end of the ear tip is positioned near a tragus and outside an ear canal.

6. The ear device according to claim 1, wherein a sound emitting side end of the ear tip is positioned where there is no contact with the ear.

7. The ear device according to claim 1, wherein in a state that the ear tip is in use, the sound emitting direction is a direction opposite to a position of the coupler viewed from the sound emitter in an array direction where the sound emitter is arranged viewed from the main body.

8. The ear device according to claim 7, wherein the sound emitting direction is an intermediate direction substantially in the middle between a depth direction of the ear canal and the array direction.

9. The ear device according to claim 1, wherein the sound conduit is a substantial cylinder or a substantial cone shape in which a cross-sectional area increases toward a sound emitting direction.

10. The ear device according to claim 1, wherein an outer shape of the ear tip is a substantial cone shape in which a cross-sectional area decreases toward a sound emitting direction.

11. The ear device according to claim 1, wherein a plurality of types of ear tips in which the sound conduits have different lengths are available for replacement, and one ear tip selected from the plurality of ear tips is attached to the sound emitter.

12. The ear device according to claim 1, wherein the sound emitter is formed in a substantial spherical shape.

13. The ear device according to claim 1, wherein,
the main body is heavier than the sound emitter, and
in a worn state, the coupler is tilted back diagonally.

14. The ear device according to claim 1, wherein in a worn state, the sound emitting direction is a substantial horizontal direction.

15. The ear device according to claim 1, wherein the main body is provided with a microphone that collects sound waves from outside.
